(19) United States
(12) Patent Application Publication
(10) Pub. No.: US 2011/0045396 A1
(43) Pub. Date: Feb. 24, 2011

(54) Charge Controlling Agent and Toner Using Metal Compound of Cyclic Phenol Sulfide

(75) Inventors: Masateru Yasumura, Yamaguchi (JP); Masami Ito, Ibaraki (JP); Yoshikazu Aoki, Fukushima (JP); Masaki Okubo, Fukushima (JP); Hideyuki Otsuka, Fukushima (JP); Jun Watanabe, Fukushima (JP)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: HODOGAYA CHEMICAL CO., LTD.

(21) Appl. No.: 12/990,484

(22) PCT Filed: May 8, 2009
(86) PCT No.: PCT/JP2009/058677

§ 371 Date: Oct. 29, 2010

(30) Foreign Application Priority Data
May 9, 2008 (JP) 2008-122860

(51) Int. Cl. G03G 9/08; C07F 3/06; C07F 15/02; C07F 3/04; G03G 9/087

(52) U.S. Cl. 430/108.3; 556/119; 556/139; 568/27; 430/108.5

(57) ABSTRACT

The present invention discloses a charge control agent which comprises a metal compound of a cyclic phenol sulfide of the following formula (1) as an active ingredient:

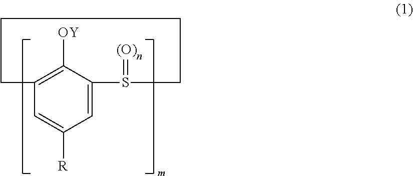

wherein at least one of several Y is a metal atom. The present invention also discloses a toner which comprises one or more kinds of said metal compound, a coloring agent and a binder resin. The charge control agent of the present invention overcomes disadvantages such as lack of sharpness of first copied images and instability of the quality of the copied images in continuously copying, and it is those applicable to recent high speed printers, which have a quick charging rise time, an excellent environmental stability since the charge amount thereof less varies depending on the changes of temperature and humidity, and a high frictional charge amount. In addition, by using said charge control agent, a toner having a negative electric with high charging performance can be provided.

### TECHNICAL FIELD OF THE INVENTION

The present invention relates to charge control agents used in an image forming apparatus which visualizes electrostatic latent images in electrophotography, the electrostatic recording and the like. It also relates to toners having a negative electric containing the charge control agent.

### BACKGROUND OF THE INVENTION

In the image forming process according to electrophotography, electrostatic latent images are formed on the inorganic photoreceptor such as selenium, selenium alloy, cadmium sulfide and amorphous silicon or on the organic photoreceptor using a charge generator and a charge transporting agent. Then, the images are developed by a toner, transferred to paper, plastic film or the like and fixed to obtain visible images.

As for photoreceptors, depending on the composition thereof, there are photoreceptors having a positive electric and those having a negative electric. In the case of forming printing parts as electrostatic latent images by exposure, the images are developed by a toner of the opposite sign electrical charge. On the other hand, in the case of reversely developing printing parts by removing the electricity thereof, the images are developed by a toner of the same sign electrical charge. A toner comprises a binder resin, a coloring agent and other additives, and a charge control agent is usually used therein in order to provide desired frictional charge characteristics such as charge speed, charge level, and charge stability, temporal stability, and environmental stability. The charge control agent largely affects the characteristics of a toner.

Conventionally, many compounds have been proposed as charge control agents having a negative electric such as monoazo metal complex compounds (see Patent Literatures 1-2), metal complex salt compounds of hydroxybenzoic acid derivatives (see Patent Literatures 3-4), metal salt compounds of aromatic dicarboxylic acid (see Patent Literature 5), calyx(n)arene compounds (see Patent Literatures 6-8), and cyclic phenol sulfides (see Patent Literatures 9-11).

However, many of the above charge control agents have some disadvantages in that affinity of a toner for a binder resin and the frictional charging ability thereof are insufficient, or, due to a slow charging risetime, first copied images are not sharp and the quality of the copies images easily changes in continuously copying. Further, some charge control agents have disadvantages in that the charging characteristics of a toner drastically vary depending on environmental conditions and thus, the image quality drastically changes according to the season.

Recent years, printers and facsimile machines each applying xerography widely spread, and the copying speed thereof becomes faster year by year. Therefore, a toner has been demanded such as those which more instantly maintain appropriate charge (having a quick charging risetime) than previous copying machines. More specifically, it has been further demanded as compared to previous toners that a future toner instantly maintains appropriate charge when switching from dormant state to output state and the frictional charging ability thereof does not deteriorate even if it is left for a long period of time.

Patent Literature 1: JP-B 3986488

Patent Literature 2: JP-A 2005-266790

Patent Literature 3: JP-A 61-069073

Patent Literature 4: JP-B 4056738

Patent Literature 5: JP-A 57-111541

Patent Literature 6: JP-B 2568675

Patent Literature 7: JP-B 2899038

Patent Literature 8: JP-B 3359657

Patent Literature 9: JP-A 2003-295522

Patent Literature 10: WO 2007/111346

Patent Literature 11: WO 2007/119797

### DISCLOSURE OF THE INVENTION

The object of the present invention is to solve disadvantages such as lack of sharpness of first copied images and instability of the quality of the copied images in continuously copying. The further object of the present invention is to provide novel charge control agents applicable to recent high speed printers, which have a quick charging risetime, an excellent environmental stability since the charge amount thereof less varies depending on the changes of temperature and humidity, and a high frictional charge amount.

The additional object of the present invention is to provide novel toners having a negative electric which comprise said charge control agent having high charging performance.

The present invention has been completed by the thorough research to solve the above problems. Namely, the present invention provides the followings.

1. A charge control agent which comprises a metal compound of a cyclic phenol sulfide of the following formula (1) as an active ingredient:

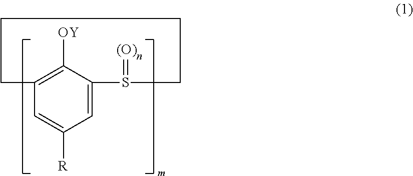

wherein R is a straight or branched alkyl group having 1 to 6 carbon atoms, a cyclic hydrocarbon group having 3 to 8 carbon atoms, a straight or branched unsaturated hydrocarbon group having 2 to 6 carbon atoms, or a substituted or unsubstituted aromatic hydrocarbon group; Y is a hydrogen atom or a metal atom; m is an integer from 4 to 9; and n is an integer of 0, 1 or 2, provided that at least one of several Y is a metal atom.

2. A toner which comprises one or more kinds of the metal compound of a cyclic phenol sulfide of the above formula (1), a coloring agent and a binder resin.

The metal compound of a cyclic phenol sulfide of the present invention is a compound excellent in both environmental stability and the charge control effect. A quick charging risetime and a high charge amount can be obtained by using the metal compound of a cyclic phenol sulfide of the present invention for a toner, and, as a result, clear images can be obtained. Therefore, the metal compound of a cyclic phenol sulfide of the present invention is particularly preferably used as a toner for a high-speed printer.

The charge control agent of the present invention is excellent in the charge control characteristics, the environment resistance and durability. When using it for a toner, it does not induce fogging and it is possible to obtain images with clear image density, high dot reproducibility and high fine line reproducibility.

In a toner comprising the metal compound of a cyclic phenol sulfide of the present invention, since the charging characteristics do not vary much in hot and humid conditions or in low and damp conditions, the stable development characteristics can be maintained.

The charge control agent comprising the metal compound of a cyclic phenol sulfide of the present invention as an active ingredient has a quicker charging risetime, a higher charge amount and charging characteristics more excellent in environmental stability than those of the conventional charge control agents. Besides, it is excellent in dispersibility and stability of the compound.

### BEST MODE FOR CARRYING OUT THE INVENTION

In the charge control agent of the present invention which comprises a metal compound of a cyclic phenol sulfide of the above formula (1), n of each molecules may be the same or different from each other, and a metal compound of a cyclic phenol sulfide wherein n is an integer of 0, 1 or 2 can be used alone or in combination with two kinds or more thereof.

Further, a metal compound of a cyclic phenol sulfide of the above formula (1) wherein m is an from 4 to 9 can be used alone or in combination with two kinds or more thereof.

Examples of straight or branched alkyl groups having 1 to 6 carbon atoms represented by R in the formula (1) include a methyl group, ethyl group, n-propyl group, 2-propyl group, n-butyl group, sec-butyl group, 2-methylpropyl group, tert-butyl group, n-pentyl group, 1-methylbutyl group, 1-ethylpropyl group, n-hexyl group, 1-methylpentyl group, 1-ethylbutyl group, 1-ethyl-2-methyl-propyl group, and 1,1,2-trimethylpropyl group. Among them, straight or branched alkyl groups having 1 to 4 carbon atoms are preferable, and a tert-butyl group is particularly preferable.

Examples of straight or branched unsaturated hydrocarbon groups having 2 to 6 carbon atoms represented by R in the formula (1) include a vinyl group, allyl group, 1-propenyl group, isopropenyl group, 2-butenyl group, 2-pentenyl group, 2-penten-4-yl group, 1,3-butandienyl group, ethynyl group, and 2-propynyl group. Among them, unsaturated hydrocarbon groups having 2 to 4 carbon atoms are particularly preferable.

Examples of cyclic hydrocarbon groups having 3 to 8 carbon atoms represented by R in the formula (1) include a cyclopropyl group, cyclobutyl group, cyclopentyl group, cyclohexyl group, cycloheptyl group, 2-cyclopenten-1-yl group, 2-cyclohexen-1-yl group, 2,4-cyclopentadien-1-yl group, and 2,4-cyclohexadien-1-yl group. Among them, cyclic hydrocarbon groups having 3 to 6 carbon atoms are particularly preferable.

Examples of substituted or unsubstituted aromatic hydrocarbon groups represented by R in the formula (1) include a phenyl group, naphthyl group, anthryl group, fluorenyl group, phenanthryl group, indenyl group, pyrenyl group, and styryl group.

Examples of substituents of substituted or unsubstituted aromatic hydrocarbon groups represented by R in the formula (1) include a fluorine atom, chlorine atom, trifluoromethyl group, and straight or branched alkyl groups having 1 to 4 carbon atoms.

Any kind of metals can be used as a metal atom represented by Y in the formula (1), and transition metals and alkali earth metals are preferable. Examples thereof include iron, cobalt, nickel, copper, zinc, titanium, vanadium, chrome, manganese, magnesium, calcium, strontium, yttrium, zirconium, niobium, molybdenum, ruthenium, rhodium, palladium, silver, barium, tantalum, tungsten, rhenium, platinum and gold. Among them, iron, cobalt, nickel, copper, zinc, titanium, magnesium, calcium and zirconium are preferable, and iron, cobalt, nickel and zinc are particularly preferable.

In the present invention, it is preferable to react the metal compound (a metal-providing agent) for preparation so that about 1 mol of a metal is reacted per 1 mol of a polymer wherein Y in the formula (1) is hydrogen. Particularly it is preferable that several Y are combinations of a metal atom(s) and a hydrogen atom(s).

A cyclic phenol sulfide which is a raw material for producing a metal compound of a cyclic phenol sulfide of the present invention can be produced by the publicly known method (refer to Patent Literatures 9 to 11, JP-A 10-081680 and WO 1998/009959, for example).

A metal compound of a cyclic phenol sulfide of the present invention can be produced from a cyclic phenol sulfide which is a raw material by the publicly known method (refer to JP-A 2000-191658, and Tetrahedron, 57, p. 5557 (2001), for example).

Examples of metal-providing agents for producing the metal compound of a cyclic phenol sulfide of the present invention include metal halides; metal salts such as metal salts of a sulfuric acid, metal salts of a nitric acid, metal salts of a phosphoric acid, metal salts of an acetic acid, metal salts of a sulfonic acid and metal salts of a salicylic acid; and metal complexes such as acetylacetone complex, bipyridine complex, phenanthroline complex and ethylenediamine complex.

As for the charge control agent of the present invention, it is preferable to adjust the volume average particle diameter to 0.1 to 20 μm for use, and further preferably 0.1 to 10 μm. When the volume average particle diameter is within the above range, the charge control agent appearing on the toner surface becomes appropriate and the desired charge control effect can be obtained. Further, the charge control agent dropping from the toner is few, and it is preferable since problems such as contamination in the machine do not occur.

Examples of the method of making the metal compound of a cyclic phenol sulfide which is the charge control agent of the present invention contained in a toner include the method comprising the steps of adding said compound to a binder resin together with a coloring agent and the like, kneading, and crushing them (crushed toner); and the method comprising the steps of adding the metal compound of a cyclic phenol sulfide to polymerizable monomers and polymerizing them to obtain the toner (polymerized toner). Thus, there are the method of adding the metal compound of a cyclic phenol sulfide to the inside of the toner particles in advance (the internal addition) and the method of adding it to the surface of the toner particles which have been produced in advance (the external addition). In the case of internally adding the metal compound of a cyclic phenol sulfide which is the charge control agent of the present invention to the toner particles, the preferable additive amount thereof is 0.1 to 10 parts by weight to 100 parts by weight of a binder resin, and more preferably 0.2 to 5 parts by weight. In the case of externally adding the metal compound of a cyclic phenol sulfide to the toner particles, the preferable additive amount thereof is 0.01 to 5 parts by weight to 100 parts by weight of a binder resin, and more preferably 0.01 to 2 parts by weight. Further, it is mechanochemically preferable to fix the metal compound of a cyclic phenol sulfide to the surface of the toner particles.

The charge control agent which comprises the metal compound of a cyclic phenol sulfide of the present invention as the active ingredient can be combined with the other known charge control agent(s) having a negative electric. Examples of the preferable combined charge control agents include azo iron complexes or complex salts, azo chromium complexes or complex salts, azo manganese complexes or complex salts, azo cobalt complexes or complex salts, azo zirconium complexes or complex salts, chromium complexes or complex salts of carboxylic acid derivatives, zinc complexes or complex salts of carboxylic acid derivatives, aluminum complexes or complex salts of carboxylic acid derivatives, and zirconium complexes or complex salts of carboxylic acid derivatives. As for the carboxylic acid derivatives, aromatic hydroxy carboxylic acids are preferable, and more preferably 3,5-di-tert-butyl salicylic acid. In addition, the examples include boron complexes or complex salts, and negative resin charge control agents.

In the case of combining the charge control agent of the present invention with the other charge control agent(s), the preferable additive amount of the other charge control agent(s) other than the charge control agent comprising the metal compound of a cyclic phenol sulfide of the present invention as an active ingredient is 0.1 to 10 parts by weight to 100 parts by weight of a binder resin.

As for the kind of the binder resins used in the present invention, any publicly known one can be used as the binder resin. Examples thereof include vinyl polymers such as styrene monomers, acrylate monomers and methacrylate monomers or the copolymers comprising two or more kinds of these monomers, polyester polymers, polyol resins, phenol resins, silicone resins, polyurethane resins, polyamide resins, furan resins, epoxy resins, xylene resins, terpene resins, coumarone-indene resins, polycarbonate resins and petroleum resins.

Examples of the styrene monomers, acrylate monomers and methacrylate monomers which form the vinyl polymers or the copolymers include the followings but not limited to them.

Examples of the styrene monomers are styrenes or derivatives thereof such as styrene, o-methylstyrene, m-methylstyrene, p-methylstyrene, p-phenylstyrene, p-ethylstyrene, 2,4-dimethylstyrene, p-n-amylstyrene, p-tert-butylstyrene, p-n-hexylstyrene, p-n-octylstyrene, p-n-nonylstyrene, p-n-decylstyrene, p-n-dodecylstyrene, p-methoxystyrene, p-chlorostyrene, 3,4-dichlorostyrene, m-nitrostyrene, o-nitrostyrene and p-nitrostyrene.

Examples of the acrylate monomers are acrylic acids or esters thereof such as acrylic acids, methyl acrylate, ethyl acrylate, propyl acrylate, n-butyl acrylate, isobutyl acrylate, n-octyl acrylate, n-dodecyl acrylate, 2-ethylhexyl acrylate, stearyl acrylate, 2-chloroethyl acrylate and phenyl acrylate.

Examples of the methacrylate monomers are methacrylic acids or esters thereof such as methacrylic acids, methyl methacrylate, ethyl methacrylate, propyl methacrylate, n-butyl methacrylate, isobutyl methacrylate, n-octyl methacrylate, n-dodecyl methacrylate, 2-ethylhexyl methacrylate, stearyl methacrylate, phenyl methacrylate, dimethylaminoethyl methacrylate and diethylaminoethyl methacrylate.

Examples of other monomers which form the vinyl polymers or the copolymers include following (1) to (18): (1) monoolefins such as ethylene, propylene, butylene and isobutylene; (2) polyenes such as butadiene and isoprene; (3) vinyl halides such as vinyl chloride, vinylidene chloride, vinyl bromide and vinyl fluoride; (4) vinyl esters such as vinyl acetate, vinyl propionate and vinyl benzoate; (5) vinyl ethers such as vinyl methyl ether, vinyl ethyl ether and vinyl isobutyl ether; (6) vinyl ketones such as methyl vinyl ketone, hexyl vinyl ketone and methyl isopropenyl ketone; (7) N-vinyl compounds such as N-vinylpyrrole, N-vinylcarbazole, N-vinylindole and N-vinylpyrrolidone; (8) vinylnaphthalenes; (9) acrylic acid or methacrylic acid derivatives such as acrylonitrile, methacrylonitrile and acrylamide; (10) unsaturated dibasic acids such as a maleic acid, citraconic acid, itaconic acid, alkenyl succinic acid, fumaric acid and mesaconic acid; (11) unsaturated dibasic acid anhydrides such as maleic anhydride, citraconic anhydride, itaconic anhydride and alkenyl succinic anhydride; (12) monoesters of unsaturated dibasic acids such as maleic acid monomethylester, maleic acid monoethylester, maleic acid monobutylester, citraconic acid monomethylester, citraconic acid monoethylester, citraconic acid monobutylester, itaconic acid monomethylester, alkenyl succinic acid monomethylester, furamic acid monomethylester and mesaconic acid monomethylester; (13) unsaturated dibasic acid esters such as dimethyl maleate and dimethyl fumarate; (14) α,β-unsaturated acids such as a crotonic acid and cinnamic acid; (15) α,β-unsaturated acid anhydrides such as crotonic anhydride and cinnamic anhydride; (16) monomers having a carboxyl group(s) such as anhydrides of the α,β-unsaturated acid and lower fatty acids, an alkenyl malonic acid, alkenyl glutaric acid, alkenyl adipic acid, and acid anhydrides and monoesters thereof; (17) hydroxyalkyl esters of acrylic acids or methacrylic acids such as 2-hydroxyethyl acrylate, 2-hydroxyethyl methacrylate and 2-hydroxypropyl methacrylate; and (18) monomers having a hydroxyl group such as 4-(1-hydroxy-1-methylbutyl)styrene and 4-(1-hydroxy-1-methylhexyl)styrene.

In the toner of the present invention, vinyl polymers or copolymers of the binder resin may have the cross-linked structure wherein they are cross-linked by a cross-linker having 2 or more vinyl groups. Examples of the cross-linkers used in such a case include aromatic divinyl compounds such as divinylbenzene and divinylnaphthalene. Examples of diacrylate compounds connected by an alkyl chain include ethylene glycol diacrylate, 1,3-butylene glycol diacrylate, 1,4-butanediol diacrylate, 1,5-pentanediol diacrylate, 1,6-hexanediol diacrylate, neopentyl glycol diacrylate, or those wherein the acrylate of the above compounds is replaced by methacrylate.

Examples of the diacrylate compounds connected by an alkyl chain comprising an ether bond(s) include diethyleneglycol diacrylate, triethylene glycol diacrylate, tetraethylene glycol diacrylate, polyethylene glycol #400 diacrylate, polyethylene glycol #600 diacrylate, dipropylene glycol diacrylate, or those wherein the acrylate of the above compounds is replaced by methacrylate.

In addition to the above examples, examples also include diacrylate compounds and dimethacrylate compounds connected by a chain comprising an aromatic group and an ether bond(s). Examples of polyester diacrylates include trade name: MANDA (by Nippon Kayaku Co., Ltd.).

Examples of polyfunctional cross-linkers include pentaerythritol triacrylate, trimethylolethane triacrylate, trimethylolpropane triacrylate, tetramethylolmethane tetraacrylate, oligoester acrylate, those wherein the acrylate of the above compounds is replaced by methacrylate, triallyl cyanurate and triallyl trimellitate.

These cross-linkers can be preferably used in an amount of 0.01 to 10 parts by weight to 100 parts by weight of other monomer components, and particularly preferably used in an amount of 0.03 to 5 parts by weight. Among these cross-linked monomers, examples of the preferably used monomers in a resin for toners in terms of fixity and anti-offset property include aromatic divinyl compounds (particularly preferably divinyl benzene) and diacrylate compounds connected by a binding chain which comprises an aromatic group and one ether bond. Among them, it is preferable to select combination of monomers so as to become a styrene copolymer or a styrene-acrylate copolymer.

Examples of polymerization initiators used for producing the vinyl polymer or the copolymer of the present invention include 2,2′-azobisisobutyronitrile, 2,2′-azobis(4-methoxy-2,4-dimethylvaleronitrile), 2,2′-azobis(2,4-dimethylvaleronitrile), 2,2′-azobis(2-methylbutyronitrile), dimethyl-2,2′-azobisisobutyrate, 1,1′-azobis(1-cyclohexanecarbonitrile), 2-(carbamoylazo)-isobutyronitrile, 2,2′-azobis(2,4,4-trimethylpentane), 2-phenylazo-2′,4′-dimethyl-4′-methoxyvaleronitrile, 2,2′-azobis(2-methylpropane), ketone peroxides such as methyl ethyl ketone peroxide, acetyl acetone peroxide and cyclohexanone peroxide, 2,2-bis(tert-butyl peroxy)butane, tert-butyl hydroperoxide, cumenehydroperoxide, 1,1,3,3-tetramethyl butyl hydroperoxide, di-tert-butyl peroxide, tert-butyl cumyl peroxide, dicumyl peroxide, α-(tert-butylperoxy)isopropyl benzene, isobutyl peroxide, octanoyl peroxide, decanoyl peroxide, lauroyl peroxide, 3,5,5-trimethyl hexanoyl peroxide, benzoyl peroxide, m-tolyl peroxide, diisopropyl peroxydicarbonate, di-2-ethylhexyl peroxydicarbonate, di-n-propyl peroxydicarbonate, di-2-ethoxyethyl peroxycarbonate, diethoxy isopropyl peroxydicarbonate, bis(3-methyl-3-methoxybutyl)peroxycarbonate, acetyl cyclohexyl sulfonyl peroxide, tert-butyl peroxyacetate, tert-butyl peroxyisobutyrate, tert-butylperoxy-2-ethylhexylate, tert-butyl peroxylaurate, tert-butyloxy benzoate, tert-butylperoxy isopropyl carbonate, di-tert-butyl peroxyisophthalate, tert-butylperoxy allyl carbonate, isoamyl peroxy-2-ethylhexanoate, di-tert-butylperoxy hexahydroterephthalate and tert-butyl peroxyazelate.

When the binder resin is a styrene-acrylate resin, in the molecular weight distribution of tetrahydrofuran (hereinafter referred to as THF) soluble parts of the resin component with the gel permeation chromatography (hereinafter referred to as GPC), a resin having at least one peak in the molecular weight area of 3,000 to 50,000 (number-average molecular weight) and having at least one peak in the molecular weight area of 100,000 or more is preferable in terms of fixity, offset property and preservative quality. As for THF soluble parts, the binder resin is preferable wherein the component having the molecular weight area of 100,000 or less is 50 to 90%. Further, a resin having the main peak in the molecular weight area of 5,000 to 30,000 is more preferable, and a resin having the main peak in the molecular weight area of 5,000 to 20,000 is most preferable.

When the binder resin is a vinyl polymer such as a styrene-acrylate resin, the acid number thereof is preferably 0.1 mgKOH/g to 100 mgKOH/g, more preferably 0.1 mgKOH/g to 70 mgKOH/g, and further more preferably 0.1 mgKOH/g to 50 mgKOH/g.

Examples of monomers which constitute polyester polymers include, as bivalent alcohols, ethylene glycol, propylene glycol, 1,3-butanediol, 1,4-butanediol, 2,3-butanediol, diethylene glycol, triethylene glycol, 1,5-pentanediol, 1,6-hexanediol, neopentyl glycol, 2-ethyl-1,3-hexanediol, bisphenol A hydride and diols obtained by polymerization of bisphenol A and cyclic ethers such as ethylene oxide and propylene oxide.

It is preferable to combine trivalent or more alcohols in order to cross-link polyester resins. Examples of the trivalent or more alcohols include sorbitol, 1,2,3,6-hexanetetrol, 1,4-sorbitan, pentaerythritol, dipentaerythritol, tripentaerythritol, 1,2,4-butanetriol, 1,2,5-pentatriol, glycerol, 2-methylpropane triol, 2-methyl-1,2,4-butanetriol, trimethylolethane, trimethylolpropane and 1,3,5-trihydroxybenzene.

Examples of the acid components which constitute the polyester polymers include benzene dicarboxylic acids or anhydrides thereof such as a phthalic acid, isophthalic acid and terephthalic acid; alkyl dicarboxylic acids or anhydrides thereof such as a succinic acid, adipic acid, sebacic acid and azelaic acid; unsaturated dibasic acids such as a maleic acid, citraconic acid, itaconic acid, alkenyl succinic acid, fumaric acid and mesaconic acid; and unsaturated dibasic acid anhydrides such as maleic anhydride, citraconic anhydride, itaconic anhydride and alkenyl succinic anhydride. Examples of the polyvalent (trivalent or more) carboxylic acid components include a trimellitic acid, pyromellitic acid, 2,5,7-naphthalene tricarboxylic acid, 1,2,4-naphthalene tricarboxylic acid, 1,2,4-butane tricarboxylic acid, 1,2,5-hexane tricarboxylic acid, 1,3-dicarboxy-2-methyl-2-methylene carboxypropane, tetra(methylene carboxy)methane, 1,2,7,8-octane tetracarboxylic acid, empol trimeric acids, anhydrides thereof, and partially lower alkyl esters.

When the binder resin is a polyester resin, in the molecular weight distribution of THF soluble parts of the resin component, a resin having at least one peak in the molecular weight area of 3,000 to 50,000 is preferable in terms of fixity and anti-offset property. As for THF soluble parts, the binder resin is preferable wherein the component having the molecular weight area of 100,000 or less is 60 to 100%. Further, a resin having at least one peak in the molecular weight area of 5,000 to 20,000 is more preferable.

When the binder resin is a polyester resin, the acid number thereof is preferably 0.1 mgKOH/g to 100 mgKOH/g, more preferably 0.1 mgKOH/g to 70 mgKOH/g, and further more preferably 0.1 mgKOH/g to 50 mgKOH/g.

In the present invention, the molecular weight distribution of the binder resin is determined by GPC using THF as a solvent.

As the binder resin which can be used in the toner of the present invention, it is possible to use, in the vinyl polymer component and/or the polyester resin component, a resin containing a monomer which can react with both resin components. Among the monomers which constitute the polyester resin component, examples of those which can react with the vinyl polymers include unsaturated dicarboxylic acids or anhydrides thereof such as a phthalic acid, maleic acid, citraconic acid and itaconic acid. Examples of the monomers which constitute the vinyl polymer component include those comprising a carboxyl group or a hydroxyl group and esters of acrylic acids or methacrylic acids.

When combining the polyester polymers, vinyl polymers and other binder resins, it is preferable to contain 60 mass % or more of the resin wherein the acid number of the total binder resin is 0.1 to 50 mgKOH/g.

In the present invention, the acid number of the binder resin component of a toner composition is determined by the following method. The basic operation is based on JIS K-0070.

(1) A sample is used after removing additives other than the binder resin (a polymer component), or the acid number and the content of each components other than the binder resin and the cross-linked binder resin are determined in advance. 0.5 to 2.0 g of the crushed sample was precisely weighed. The weight of the polymer component is defined as Wg. For example, when the acid number of the binder resin is determined from a toner, the acid number and the content of each of a coloring agent, a magnetic material or the like are separately determined. Then, the acid number of the binder resin is calculated.

(2) The sample is poured in a 300 mL beaker. Then, 150 mL of a mixed solution of toluene/ethanol (volume ratio=4/1) is added thereto and dissolved.

(3) The mixed solution is tiltrated using 0.1 mol/L of a KOH ethanol solution with a potentiometric tiltrator.

(4) The usage of the KOH solution in (3) is defined as S(mL). At the same time, the blank is determined and the usage of the KOH solution at that time is defined as B(mL). Then, the acid number is calculated using the following formula (1). Meanwhile, f is a factor of the KOH concentration.

Acid number(mgKOH/g)=[(S−B)×f×5.61]/W (1)

As for the binder resin of a toner and compositions containing the binder resin, the glass transition temperature (Tg) thereof is preferably 35 to 80° C. and particularly preferably 40 to 75° C., in terms of the preservative quality of a toner. When Tg is within the above range, a toner does not easily deteriorate even in high temperature atmosphere, and offset does not easily occur upon fixing. Further, fixity becomes better.

Examples of the magnetic materials which can be used in the present invention are followings: (1) magnetic iron oxides such as magnetite, maghemite and ferrite, and iron oxides containing other metallic oxides; (2) metals such as iron, cobalt and nickel, or alloyed metals of said metals and the metals such as aluminum, cobalt, copper, lead, magnesium, tin, zinc, antimony, beryllium, bismuth, cadmium, calcium, manganese, selenium, titanium, tungsten and vanadium; and (3) mixtures thereof.

Specific examples of the magnetic materials are Fe₃O₄, γ—Fe₂O₃, ZnFe₂O₄, Y₃Fe₅O₁₂, CdFe₂O₄, Gd₃Fe₅O₁₂, CuFe₂O₄, PbFe₁₂O, NiFe₂O₄, NdFe₂O, BaFe₁₂O₁₉, MgFe₂O₄, MnFe₂O₄, LaFeO₃, iron powder, cobalt powder and nickel powder. The above mentioned magnetic materials are used by itself or by combination of two kinds or more of them. A particularly preferable magnetic material is fine powders of ferrosoferric oxide or γ-iron sesquioxide.

In addition, magnetic iron oxides such as magnetite, maghemite, ferrite, etc containing dissimilar elements or the mixtures thereof are also usable. Examples of the dissimilar elements include lithium, beryllium, boron, magnesium, aluminum, silicon, phosphorus, germanium, zirconium, tin, sulfur, calcium, scandium, titanium, vanadium, chromium, manganese, cobalt, nickel, copper, zinc and gallium. The preferable dissimilar elements are selected from the group consisting of magnesium, aluminum, silicon, phosphorus and zirconium. The dissimilar elements may be incorporated in the crystal lattice of iron oxides or in the iron oxides themselves as oxides, or they may exist on the surface of iron oxides as oxides or hydroxides. It is preferable that the dissimilar elements are contained as oxides.

The above dissimilar elements can be incorporated in the particles by the steps comprising of mixing salts of each dissimilar elements upon producing a magnetic material, and then adjusting pH thereof. Further, the dissimilar elements can be precipitated on the surface of the particles by the steps comprising of adjusting pH thereof after the production of the magnetic particles, or adding salts of each dissimilar elements and adjusting pH thereof.

The usage of the magnetic materials is 10 to 200 parts by weight and preferably 20 to 150 parts by weight to 100 parts by weight of the binder resin. The number average particle diameter of these magnetic materials is preferably 0.1 to 2 μm and more preferably 0.1 to 0.5 μm. The number average particle diameter can be determined by taking a magnified photograph of the particles with a transmission electron microscope and then measuring it with a digitizer or the like.

As for the magnetic characteristics of the magnetic materials, it is preferable that, when 10K Oersted is applied, the magnetic characteristics are coercivity of 20 to 150 Oersted, saturated magnetization of 50 to 200 emu/g, and remanent magnetization of 2 to 20 emu/g.

The magnetic materials can also be used as coloring agents. Examples of the coloring agents usable in the present invention include, in the case of a black toner, black or blue dye compounds or pigments. Examples of the black or blue pigments include carbon black, aniline black, acetylene black, phthalocyanine blue and indanthrene blue. Examples of the black or blue dye compounds include azo dye compounds, anthraquinone dye compounds, xanthene dye compounds and methine dye compounds.

When using coloring agents for color toners, examples of the coloring agents are the followings. Examples of magenta coloring agents include condensed azo compounds, diketopyrrolopyrrole compounds, anthraquinone compounds, quinacridone compounds, basic dye compounds, lake dye compounds, naphthol dye compounds, benzimidazolone compounds, thioindigo compounds and perylene compounds. More specifically, examples of the pigmentary magenta coloring agents include C.I. pigment red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48, 49, 50, 51, 52, 53, 54, 55, 57, 58, 60, 63, 64, 68, 81, 83, 87, 88, 89, 90, 112, 114, 122, 123, 163, 184, 202, 206, 207, 209; C.I. pigment violet 19; C.I. vat red 1, 2, 10, 13, 15, 23, 29, 35; methyl violet lake, eosin lake, rhodamine lake B, alizarine lake and brilliant carmine lake 3B.

Though it is acceptable to use the above pigment by itself, it is preferable in terms of the image quality of full-color images to combine the dye compound and the pigment so as to improve the color definition.

Examples of dye magenta coloring agents include oil soluble dye compounds such as C.I. solvent red 1, 3, 8, 23, 24, 25, 27, 30, 49, 81, 82, 83, 84, 100, 109, 121; C.I. disperse red 9; C.I. solvent violet 8, 13, 14, 21, 27; C.I. disperse violet 1; and basic dye compounds such as C.I. basic red 1, 2, 9, 12, 13, 14, 15, 17, 18, 22, 23, 24, 27, 29, 32, 34, 35, 36, 37, 38, 39, 40; and C.I. basic violet 1, 3, 7, 10, 14, 15, 21, 25, 26, 27, 28.

It is possible to use, as cyan coloring agents, copper phthalocyanine compounds and derivatives thereof, anthraquinone, and basic dye lake compounds. More specifically, examples of pigmentary cyan coloring agents include C.I. pigment blue 2, 3, 15, 16, 17; C.I. vat blue 6; C.I. acid blue 45; and copper phthalocyanine pigments wherein 1 to 5 phthalimidemethyl group(s) is substituted to a phthalocyanine skeleton. It is possible to use the agent by blending a green coloring agent such as C.I. pigment green7, 12, 37 and 38.

Representative examples of phthalocyanine dye compounds include C.I. solvent blue 25, 55, 70; C.I. direct blue 25, 86; alkali blue lake; and victoriablue lake.

Examples of yellow coloring agents include condensed azo compounds, isoindolinone compounds, anthraquinone compounds, azo metal complexes, methine compounds and allylamide compounds. More specifically, examples of yellow pigments include C.I. pigment yellow 1, 2, 3, 4, 5, 6, 7, 10, 11, 12, 13, 14, 15, 16, 17, 23, 65, 73, 83, 97, 180, 185; C.I. vat yellow 1, 3, 20; C.I. solvent yellow 162; quinoline yellow; and tartrazine lake.

The usage of the above coloring agents is preferably 0.1 to 20 parts by weight to 100 parts by weight of the binder resin.

The toner of the present invention may be mixed with a carrier to be used as a two component developer. As for the carriers used in the present invention, it is possible to use both usual carriers such as ferrite and magnetite and resin coated carriers.

The resin coated carrier comprises carrier core particles and a coating material which is a resin coating the surface of the carrier core particles. Preferable examples of the resins used as the coating material include styrene-acrylate resins such as styrene-acrylic acid ester copolymers and styrene-methacrylic acid ester copolymers; acrylate resins such as acrylic acid ester copolymers and methacrylic acid ester copolymers; fluorine-containing resins such as polytetrafluoroethylene, monochlorotrifluoroethylene polymers and polyvinylidene-fluoride; silicone resins; polyester resins; polyamide resins; polyvinyl butyral; and aminoacrylate resins. In addition to them, examples include resins which can be used as a coating material of the carrier such as iomonomer resins and polyphenylene sulfide resins. These resins are used by itself or by combination of two or more kinds of them.

Besides, a binder carrier core wherein magnetic powders are dispersed in a resin is also usable.

As for the method of coating the surface of a carrier core with at least a resin coating agent in a resin coated carrier, it is possible to apply the method comprising the steps of dissolving or dispersing a resin in a solvent, and making the solvent adhere on the carrier core to be coated; or the method of simply mixing a resin in a powdery condition. The ratio of the resin coating material to the resin coated carrier can be properly determined, and it is preferably 0.01 to 5 mass % to the resin coated carrier and more preferably 0.1 to 1 mass %.

The usage examples of a coating agent comprising a mixture of two or more kinds of compounds for coating a magnetic material include: (1) a coating agent treated with 12 parts by weight of a mixture of dimethyldichlorosilane and dimethyl silicon oil (mass ratio=1:5) to 100 parts by weight of fine powders of a titanium oxide; and (2) a coating agent treated with 20 parts by weight of a mixture of dimethyldichlorosilane and dimethyl silicon oil (mass ratio=1:5) to 100 parts by weight of fine powders of silica.

Among the above resins, a styrene-methyl methacrylate copolymer, a mixture of a fluorine-containing resin and a styrene copolymer, or a silicone resin is preferably used. Particularly, a silicone resin is preferable.

Examples of the mixture of a fluorine-containing resin and a styrene copolymer include a mixture of polyvinylidene-fluoride and a styrene-methyl methacrylate copolymer, a mixture of polytetrafluoroethylene and a styrene-methyl methacrylate copolymer, and a mixture of a vinylidene fluoride-tetrafluoroethylene copolymer (copolymer mass ratio=10:90-90:10), a styrene-acrylic acid-2-ethylhexyl copolymer (copolymer mass ratio=10:90-90:10) and a styrene-acrylic acid-2-ethylhexyl-methyl methacrylate copolymer (copolymer mass ratio=20-60:5-30:10:50).

Examples of the silicone resin include modified silicone resins which are produced by the reaction of a silicone resin with a nitrogen-containing silicone resin(s) and a nitrogen-containing silane coupling agent(s).

As for magnetic materials of a carrier core, it is possible to use oxides such as ferrite, iron excess ferrite, magnetite and γ-iron oxide; metals such as iron, cobalt and nickel; or alloyed metals of said metals. Examples of elements contained in these magnetic materials include iron, cobalt, nickel, aluminum, copper, lead, magnesium, tin, zinc, antimony, beryllium, bismuth, calcium, manganese, selenium, titanium, tungsten and vanadium. The preferable ones are copper-zinc-iron ferrite comprising copper, zinc and iron as main components, and manganese-magnesium-iron ferrite comprising manganese, magnesium and iron as main components.

The resistance value of a carrier is preferably adjusted to 106 to 10¹⁰ Ω/cm by adjusting concavity and convexity of the surface of the carrier and the amount of the resin to be coated. As for the particle diameter of the carrier, though the particle diameter of 4 to 200 μm can be used, 10 to 150 μm is preferable and 20 to 100 μm is more preferable. Particularly, a resin coated carrier preferably has 50% particle diameter of 20 to 70 μm.

In a two component developer, it is preferable to use the toner of the present invention in an amount of 1 to 200 parts by weight to 100 parts by weight of the carrier. It is more preferable to use the toner in an amount of 2 to 50 parts by weight to 100 parts by weight of the carrier.

The toner of the present invention may further contain a wax. Examples of the wax used in the present invention include the followings: aliphatic hydrocarbon waxes such as low-molecular-weight polyethylene, low-molecular-weight polypropylene, polyolefin wax, microcrystalline wax, paraffin wax and Sasol wax; oxides of aliphatic hydrocarbon waxes such as oxidized polyethylene wax; block copolymers thereof; botanical waxes such as candelilla wax, carnauba wax, Japan wax and jojoba wax; animal waxes such as bees wax, lanolin and whale wax; mineral waxes such as ozokerite, ceresin and petrolatum; waxes comprising fatty acid esters as a main component, such as wax of montanic acid esters and castor wax; and partially or wholly deoxidized fatty acid esters such as deoxidized carnauba wax.

Further examples of the wax include saturated straight fatty acids such as a palmitic acid, stearic acid, montanic acid and straight alkyl carboxylic acids further comprising a straight alkyl group; unsaturated fatty acids such as a brassidic acid, eleostearic acid and parinaric acid; saturated alcohols such as stearyl alcohol, eicosyl alcohol, behenyl alcohol, carnaubil alcohol, ceryl alcohol, mesilyl alcohol and long-chain alkyl alcohol; polyalcohols such as sorbitol; fatty acid amides such as linoleic acid amide, olefinic acid amide and lauric acid amide; saturated fatty acid bisamides such as methylene bis-capric acid amide, ethylene bis-lauric acid amide and hexamethylene bis-stearic acid amide; unsaturated fatty acid amides such as ethylene bisoleic acid amide, hexamethylene bisoleic acid amide, N,N′-dioleyl adipic acid amide and N,N′-dioleyl sebacic acid amide; aromatic bisamides such as m-xylene bis-stearic acid amide and N,N′-distearyl isophthalic acid amide; metallic salts of fatty acids such as calcium stearate, calcium laurate, zinc stearate and magnesium stearate; waxes wherein an aliphatic hydrocarbon wax is grafted by using a vinyl monomer such as styrene and an acrylic acid; partially esterified compounds of polyalcohol and a fatty acid such as behenic acid monoglyceride; and methylester compounds having a hydroxyl group which are obtained by hydrogenating a vegetable oil.

Examples of the preferably used wax include polyolefin obtained by radical-polymerizing olefin under high pressure; polyolefin obtained by purifying a low-molecular-weight by-product obtained in the polymerization of high-molecular-weight polyolefin; polyolefin polymerized under low pressure by using a catalyst such as Ziegler catalyst and metallocene catalyst; polyolefin polymerized by using radiation, electromagnetic wave or light; low-molecular-weight polyolefin obtained by thermally decomposing high-molecular-weight polyolefin; paraffin wax, microcrystalline wax and Fischer-Tropsch wax; synthetic hydrocarbon waxes synthesized by Synthol process, Hydrocol process, Arge process, or the like; synthetic waxes having a compound of one carbon atom as a monomer; hydrocarbon waxes having a functional group such as a hydroxyl group and a carboxyl group; a mixture of a hydrocarbon wax and a hydrocarbon wax having a functional group; and waxes wherein the above waxes are grafted by a vinyl monomer such as styrene, ester maleate, acrylate, methacrylate and maleic anhydride.

Further, it is preferable to use waxes of which molecular weight distribution is sharpened by treating them with Press sweating process (method), solvents, recrystallization method, vacuum distillation method, supercritical gas extraction method or solution crystallization method; or waxes from which low-molecular-weight solid fatty acids, low-molecular-weight solid alcohols, low-molecular-weight solid compounds or other impurities are removed.

The wax used in the present invention preferably has the melting point of 70 to 140° C. and more preferably 70 to 120° C. in order to balance fixity and anti-offset property. When the melting point is within the above range, the blocking resistance becomes better and the anti-offset effect easily occurs.

Further, combination of two or more different kinds of waxes can develop both the plasticizing action and the mold-releasing action at the same time, each of which is the action of waxes.

Examples of waxes having the plasticizing action are waxes having a low melting point, those having a branched molecular structure, and those having a polar group in the structure. Examples of waxes having the mold-releasing action are waxes having a high melting point, those having a straight molecular structure, and those having nonpolar molecules which do not have any functional group. As usage examples, there are the combination of two or more kinds of waxes between which the difference of the melting points is 10 to 100° C.; and the combination of polyolefin and grafted polyolefin.

When selecting two kinds of waxes, in the case of the waxes having the similar structure, the wax which relatively has lower melting point exerts the plasticizing action, and the wax which relatively has higher meting point exerts the mold-releasing action. At that time, when the difference of each melting points is 10 to 100° C., the functional separation is effectively exerted. In such a case, when at least one of the waxes preferably has the melting point of 70 to 120° C. and more preferably 70 to 100° C., the waxes tend to easily exert the effect of the functional separation.

Besides, the wax which relatively has a branched molecular structure, has a polar group or is modified by a component different from the main component exerts the plasticizing action. The wax which relatively has a straight molecular structure, has nonpolar molecules which do not have any functional group or is unmodified and straight exerts the mold-releasing action. Examples of the preferable combination thereof include a combination of polyethylene homopolymer or copolymer having ethylene as the main component and polyolefin homopolymer or copolymer having olefin other than ethylene as the main component; a combination of polyolefin and grafted polyolefin; a combination of a hydrocarbon wax and an alcohol wax, a fatty acid wax or an ester wax; a combination of Fischer-Tropsch wax or a polyolefin wax and a paraffin wax or a microcrystalline wax; a combination of Fischer-Tropsch wax and a polyolefin wax; a combination of a paraffin wax and a microcrystalline wax; and a combination of a hydrocarbon wax and a carnauba wax, a candelilla wax, a rice bran wax or a montan wax.

In each case, in the endothermic peak observed in the DSC measurement of the toner, it is preferable that the peak-top temperature of the maximum peak is within 70 to 110° C. It is more preferable that the maximum peak is within 70 to 110° C. This makes it easier to balance the preservative quality and the fixity of the toner.

In the toner of the present invention, it is effective to use these waxes in a total content of preferably 0.2 to 20 parts by weight and more preferably 0.5 to 10 parts by weight to 100 parts by weight of the binder resin.

In the present invention, the melting point of a wax is defined as the peak-top temperature of the maximum peak in the endothermic peak of the wax observed in DSC.

In the present invention, it is preferable to conduct the DSC measurement of the wax or the toner with a high-precision intraheater power-compensation type differential scanning calorimeter. The measurement method is based on ASTM D3418-82. The DSC curve used in the present invention is the curve measured when a sample is heated at temperature velocity of 10° C./min. after heating and cooling the sample once and taking a record in advance.

A flow improver may be added to the toner of the present invention. A flow improver improves flowability of the toner (makes it easier to flow) by being added to the surface of the toner. Examples thereof include fluorine resin powders such as carbon black, fine powders of vinylidene fluoride and fine powders of polytetrafluoroethylene; fine powders of silica such as wet processed silica and dry processed silica; fine powders of unoxidized titanium; fine powders of alumina; and treated silica, treated titanium oxide and treated alumina wherein each of the above fine powders is surface-treated with a silane coupling agent, titanium coupling agent or silicone oil. Among them, fine powders of silica, fine powders of unoxidized titanium and fine powders of alumina are preferable, and the treated silica wherein each of said fine powders is surface-treated with a silane coupling agent or silicone oil is further more preferable. The particle diameter of the flow improver is preferably 0.001 to 2 μm as the average primary particle diameter and particularly preferably 0.002 to 0.2 μm.

The preferable fine powders of silica are fine powders produced by oxidizing the gas phase of silicon halides, and referred to as dry processed silica or fumed silica.

Examples of the marketed silica fine powders produced by oxidizing the gas phase of silicon halides include the following trade names: AEROSIL-130, -300, -380, -TT600, -MOX170, -MOX80 and -COK84 (all by Nippon Aerosil Co., Ltd.); Ca-O-SiL-M-5, -MS-7, -MS-75, -HS-5 and -EH-5 (all by CABOT K.K.); Wacker HDK-N20 V15, -N20E, -T30 and -T40 (all by Wacker-Chemie GmbH); D-C FineSilica (by Dow Corning Toray Co., Ltd.); and Franso 1 (by Fransi1 K.K.).

In addition, treated silica fine powders wherein the silica fine powders produced by oxidizing the gas phase of silicon halides are hydrophobized is more preferable. Among the treated silica fine powders, those each of which is treated so that the hydrophobizing degree thereof measured in methanol titration test preferably indicates 30 to 80% are particularly preferable. Hydrophobizing is given by chemically or physically treating silica fine powders with an organic silicon compound(s) which reacts with silica fine powders or physically adsorbs to them. The preferable method is that comprising the step of treating silica fine powders produced by oxidizing the gas phase of silicon halides with an organic silicon compound(s).

Examples of the organic silicon compound include hydroxypropyl trimethoxysilane, phenyltrimethoxysilane, n-hexadecyltrimethoxysilane, n-octadecyltrimethoxysilane, vinylmethoxysilane, vinyltriethoxysilane, vinyltriacetoxysilane, dimethylvinylchlorosilane, divinylchlorosilane, γ-methacryloxypropyltrimethoxysilane, hexamethyldisilane, trimethylsilane, trimethylchlorosilane, dimethyldichlorosilane, methyltrichlorosilane, allyldimethylchlorosilane, allylphenyldichlorosilane, benzyldimethylchlorosilane, bromomethyldimethylchlorosilane, α-chloroethyltrichlorosilane, β-chloroethyltrichlorosilane, chloromethyldimethylchlorosilane, triorganosilyl mercaptan, trimethylsilyl mercaptan, triorganosilyl acrylate, vinyldimethylacetoxysilane, dimethylethoxysilane, trimethylethoxysilane, trimethylmethoxysilane, methyltriethoxysilane, isobutyltrimethoxysilane, dimethyldimethoxysilane, diphenyldiethoxysilane, hexamethyldisiloxane, 1,3-divinyltetramethyldisiloxane, 1,3-diphenyltetramethyldisiloxane and dimethylpolysiloxane which has 2 to 12 siloxane units per one molecule and contains 0 to 1 hydroxyl group attached to Si in each unit located on ends. Further, examples include silicone oils such as dimethylsilicone oil. Each of the above compounds is used by itself or by a mixture of two or more kinds of them.

The number average particle diameter of the flow improver is preferably 5 to 100 nm and more preferably 5 to 50 nm. The specific surface area thereof by the nitrogen adsorption measured by BET method is preferably 30 m²/g or more and more preferably 60 to 400 m²/g. The specific surface area of the surface-treated fine powders is preferably 20 m²/g or more and particularly preferably 40 to 300 m²/g. The preferable applied amount of these fine powders is 0.03 to 8 parts by weight to 100 parts by weight of toner particles.

To the toner of the present invention, it is possible to add other additives such as various metallic soaps, fluorine surfactants and dioctyl phthalate; conductivity giving agents such as tin oxide, zinc oxide, carbon black and antimony oxide; or inorganic fine powders of titanium oxide, aluminum oxide and alumina, if necessary, in order to protect a photoreceptor and a carrier, improve cleaning property, control heat property, electric property, and physical property, control resistance, control softening point and improve the fixation ratio. These inorganic fine powders may be hydrophobized, if necessary. Further, it is possible to use, as an image development improver, a small amount of lubricants such as polytetrafluoroethylene, zinc stearate and polyvinylidene-fluoride; abrasives such as cesium oxide, silicon carbide and strontium titanate; anticaking agents; or white microparticles and black microparticles each of which have the opposite polarity of the toner particles.

It is also preferable to treat the above additives with silicone varnish, various modified silicone varnishes, silicone oil, various modified silicone oils, silane coupling agents, silane coupling agents having a functional group(s), treatment agents such as other organic silicon compounds or various other treatment agents, in order to control the charge amount.

The charge control agent of the present invention can be sufficiently mixed by stirring with the above additive(s) and the toner by a mixer such as Henschel mixer, a ball mill, Nauta mixer, a V-type mixer, a W-type mixer and a supermixer; and said mixture be uniformly externally added to the surface of the toner particles to obtain the subject toner for static electric charge development.

Since the toner of the present invention is thermally stable and not changed by heat in the process of electrophotography, it is possible to maintain stable charging characteristics. In addition, since the toner uniformly disperses in any binder resin, the charging distribution of a fresh toner is fairly uniform. Accordingly, as for the toner of the present invention, changes are hardly seen in both the saturated frictional charge amount and the charging distribution of the untransferable toner and the collected toner (a discarded toner) thereof as compared with those of the fresh toner. When reusing the discarded toner collected from the toner for static electric charge image development of the present invention, the gap between the fresh toner and the discarded toner can be further reduced by selecting a polyester resin containing aliphatic diol as the binder resin, or by producing the toner in accordance with the method comprising the steps of selecting a metal-bridged styrene-acrylate copolymer as the binder resin and adding large quantities of polyolefin thereto.

As for the method of producing the toner of the present invention, the toner can be produced by the known production method. For example, the preferable production method is the method (crushing method) comprising the steps of sufficiently mixing the above mentioned toner constituent materials such as a binder resin, a charge control agent and a coloring agent by a mixer such as a ball mill; then, sufficiently kneading the mixture by a heat kneading machine such as a heat roll kneader; solidifying by cooling, crushing and classifying the mixture to obtain a toner.

The toner can also be produced by dissolving the above mixture in a solvent, atomizing, drying and classifying it. Further, the toner can also be produced by the polymerization method, which comprises the steps of mixing specific materials to a monomer constituting the binder resin to prepare an emulsion or a suspension, and polymerizing the solution. As for a microcapsule toner comprising a core material and a shell material, such toner can be produced by the method comprising the step of making specific materials contain in a core material or a shell material, or both of them. Further, if necessary, the toner of the present invention can be produced by sufficiently mixing a needed additive(s) and toner particles by a mixer such as Henschel mixer.

The method of producing the toner of the present invention by the above crushing method is further illustrated as follows. First, a binder resin, a coloring agent, a charge control agent and other necessary additives are uniformly mixed. They can be mixed with a known mixer such as Henschel mixer, a supermixer and a ball mill. The obtained mixture is heat-molten and kneaded with a hermetically sealed kneader or a single or double screw extruder. After cooling down the kneaded mixture, it is coarsely crushed with a crusher or a hammer mill, and then finely milled with a pulverizer such as a jet mill and a high-speed rotor whirling mill. Then, the obtained powders are classified to a specific particle size with a wind force classifier such as Elbow-jet of an inertial classification system utilizing the Coanda effect, Microplex of a cyclone (centrifugal) classification system or a DS separator. When further adding an external additive(s) to the surface of the toner, the toner and the external additive(s) are stirred and mixed with a high-speed mixer such as Henschel mixer and a supermixer.

The toner of the present invention can also be produced by the suspension polymerization method or the emulsion polymerization method. The suspension polymerization method comprises the following steps. A polymerizable monomer, a coloring agent, a polymerization initiator, a charge control agent and, if necessary, a cross-linker and other additives are uniformly dissolved or dispersed to prepare a monomer composition. The monomer composition is dispersed in the continuous phase containing a dispersion stabilizer and said composition such as the aqueous phase with a suitable mixer or disperser such as a homomixer, a homogenizer, an atomizer, a microfluidizer, a one-fluid nozzle, a gas-liquid fluid nozzle and an electric emulsifying machine. Preferably, the stirring speed, temperature and time are controlled so that droplets of the polymerizable monomer composition have the desired toner particle size, and granulation is conducted. At the same time, the polymerization reaction is conducted at 40 to 90° C. to be able to obtain toner particles having the desired particle diameter. The obtained toner particles are washed, filtered out and dried. As for the external addition after producing the toner particles, the above mentioned method can be used.

When producing the toner by the emulsion polymerization method, though the toner particles thereof are more uniform than those obtained by the suspension polymerization method, the average particle diameter thereof is 0.1 to 1.0 μm and extremely small. Therefore, in some cases, a toner can be produced by the seed polymerization in which an emulsified particle becomes a core and a polymerizable monomer is added thereto afterward to grow the particle, or by the method comprising the steps of unifying and fusing emulsified particles to a suitable average particle diameter.

According to the production of the toner by these polymerization methods, since there is no crushing process, there is no need to give brittleness to toner particles. Thus, it is possible to use large amounts of substances having a low softening point, of which use was difficult in prior crushing methods, and that makes it possible to widen choices of materials. Further, since a mold-releasing agent or a coloring agent each of which is a hydrophobizing material is not easily exposed on the surface of the toner particles, it is possible to decrease contamination in a toner support member, a photoreceptor, a transferring roller, a fixing machine or the like.

The production of the toner of the present invention by the polymerization method can further improve properties such as image reproducibility, transferability and color reproducibility. Further, a toner having a sharp particle size distribution can be comparatively easily obtained by minimizing the particle diameter of the toner in order to apply to tiny dots.

As for the polymerizable monomer used in producing the toner of the present invention by the polymerization method, a vinyl polymerizable monomer of which radical polymerization is possible is used. As the vinyl polymerizable monomer, a monofunctional polymerizable monomer or a polyfunctional polymerizable monomer can be used.

Examples of the monofunctional polymerizable monomer include styrene polymerizable monomers such as styrene, α-methylstyrene, β-methylstyrene, o-methylstyrene, m-methylstyrene, p-methylstyrene, 2,4-dimethylstyrene, p-n-butylstyrene, p-tert-butylstyrene, p-n-hexylstyrene and p-phenylstyrene; acrylate polymerizable monomers such as methyl acrylate, ethyl acrylate, n-propyl acrylate, isopropyl acrylate, n-butyl acrylate, isobutyl acrylate, tert-butyl acrylate, n-amyl acrylate, n-hexyl acrylate, 2-ethylhexyl acrylate, n-octyl acrylate, benzyl acrylate, dimethylphosphate methyl acrylate, dibutylphosphate ethyl acrylate and 2-benzoyloxy ethyl acrylate; methacrylate polymerizable monomers such as methyl methacrylate, ethyl methacrylate, n-propyl methacrylate, isopropyl methacrylate, n-butyl methacrylate, isobutyl methacrylate, tert-butyl methacrylate, n-amyl methacrylate, n-hexyl methacrylate, 2-ethylhexyl methacrylate, n-octyl methacrylate, diethylphosphate methacrylate and dibutylphosphate ethyl methacrylate; unsaturated aliphatic monocarboxylic acid esters; vinyl esters such as vinyl acetate, vinyl propionate and vinyl benzoate; vinyl ethers such as vinyl methyl ether and vinyl isobutyl ether; and vinyl ketones such as methyl vinyl ketone, hexyl vinyl ketone and isopropyl vinyl ketone.

Examples of the water-soluble initiator which is used when producing the toner of the present invention by the polymerization method include ammonium persulfate, potassium persulfate, 2,2′-azobis(N,N′-dimethylene isobutyroamidine) hydrochloride, 2,2′-azobis(2-aminodipropane) hydrochloride, azobis(isobutylamidine) hydrochloride, 2,2′-azobisisobutyronitrile sodium sulfonate, ferrous sulfate and hydrogen peroxide.

The additive amount of a polymerization initiator is preferably 0.5 to 20 parts by weight to 100 parts by weight of a polymerizable monomer. The polymerization initiator may be used by itself or by combination thereof. Examples of the dispersant used in the production of a polymerized toner include inorganic oxides such as tricalcium phosphate, magnesium phosphate, aluminum phosphate, zinc phosphate, calcium carbonate, magnesium carbonate, aluminum hydroxide, calcium metasilicate, calcium sulfate, barium sulfate, bentonite, silica and alumina. As for organic compounds, for example, polyvinyl alcohol, gelatin, methylcellulose, methylhydroxypropylcellulose, ethyl cellulose, sodium salt of carboxymethylcellulose, starch, or the like is used. These dispersants are preferably used in an amount of 0.2 to 2.0 parts by weight to 100 parts by weight of a polymerizable monomer.

Though the marketed dispersants may be used as they are, in order to obtain fine disperse particles having a uniform particle size, the above inorganic compounds can also be produced by high-speed stirring in a disperse medium.

As for the toner obtained by the polymerization method, the concavity and convexity of the toner particles tend to be smaller than those of the toner obtained by the crushing method in which special treatment is not conducted. Since such toner particles are amorphous, the contact area between an electrostatic latent image support member and the toner increases, and it makes the toner adhesion stronger. As a result, the contamination in the machine is decreased and it becomes easier to obtain higher image density and higher quality images.

As for the toner produced by the crushing method, the concavity and convexity of the toner surface can be decreased by the methods such as the hot-water bath method which comprises the steps of dispersing toner particles in water and heating the solution; heat treatment method comprising the step of making toner particles pass through thermal current; and the mechanical impact method comprising the step of treating the particles by giving the mechanical energy. Examples of the effective equipments for decreasing the concavity and convexity include a Mechanofusion system (by Hosokawa Micron Corp.) applying the dry mechanochemical treatment; an I-type jet mill; a hybridizer (by Nara Machinery Co., Ltd.) which is a mixing equipment with a rotor and a liner; and Henschel mixer which is a mixer having high-speed blades.

As one of the values which show the degree of the concavity and convexity of the toner particles, an average circularity degree can be used. The average circularity degree (C) indicates the value which is calculated as follows. First, a circularity degree (Ci) is calculated by the following formula (2). Then, the sum of the circularity degrees of all measured particles is divided by the number of all measured particles (m) as mentioned in the following formula (3).

$$\begin{matrix}Circularity degree ( Ci ) = \begin{matrix}Boundary length of the circle having the same \\ projected area as that of a particle \\ Boundary length of the projected image of a \\ particle\end{matrix} & ( 2 ) \\ \begin{matrix}Average \\ circularity \\ degree\end{matrix} C = {\sum }_{i = 1}^{m} Ci / m & ( 3 )\end{matrix}$$

The above circularity degree (Ci) is measured using a flow particle image analyzer such as FPIA-1000 by TOA Medical Electronics Co., Ltd. As for the measurement method, first, about 5 mg of a toner is dispersed in 10 mL of water in which about 0.1 mg of a nonionic surfactant is dissolved to prepare a dispersion solution. Ultrasonic wave (20 kHz, 50W) is irradiated to the dispersion solution for 5 minutes, and the solution is prepared to become the concentration of 5000 to 20000/μL. Then, the distribution of the circularity degree of a particle having the diameter which is equivalent to the circle of 0.60 μm or more and less than 159.21 μm is measured with the flow particle image analyzer.

The value of the average circularity degree is preferably 0.955 to 0.990. It is further preferable to prepare toner particles so that the value becomes 0.960 to 0.985 since events which cause the increase in the left toner after transferring decrease and another transferring tends not to easily occur.

In the case of the toner of the present invention, in terms of clear images and productivity of the toner, the particle diameter of the toner is preferably 2 to 15 μm in the average particle diameter on volumetric basis in the measurement with a laser particle size distribution analyzer such as a micron sizer by Seishin Enterprise Co., Ltd, for example. 3 to 12 μm thereof is more preferable. When the average particle diameter is beyond 15 μm, the resolution or sharpness of images tends to weaken. When the average particle diameter is within the above range, the resolution and sharpness are better, and the yield rate upon production of a toner is also high. Further, it is preferable in that problems such as toner spatters in the machine or skin penetration do not occur.

As for the particle size distribution of a toner, in the case of the toner of the present invention, it is preferable that the content of particles of 2 μm or smaller accounts for 10 to 90% on number basis of the toner, which is measured by a Coulter counter (TA-II, by Coulter K.K.), for example. Besides, it is preferable that the content of particles of 12.7 μm or larger accounts for 0 to 30% on volumetric basis of the toner.

In the case of the toner for static electric charge development of the present invention, it is preferable that the specific surface area of the toner is 1.2 to 5.0 m²/g according to the BET specific surface area measurement wherein nitrogen is used as deadsorption gas. It is more preferable that the specific surface area is 1.5 to 3.0 m²/g. The measurement of the specific surface area comprises the steps, for example, of desorbing adsorption gas on the surface of the toner at 50° C. for 30 minutes with a BET specific surface area measurement device (such as FlowSorbII2300 by Shimadzu Corporation); adsorbing nitrogen gas again by rapidly cooling down the toner with liquid nitrogen; and then heating it again up to 50° C. The specific surface area is defined as the value calculated from the amount of desorbed gas at that time.

In the case of the toner of the present invention, the apparent ratio (the powder density) thereof is measured with a powder tester (by Hosokawa Micron Corp., for instance), for example. The ratio of a non-magnetic toner is preferably 0.2 to 0.6 g/cm³. The ratio of a magnetic toner is preferably 0.2 to 2.0 g/cm³, though it depends on a kind of magnetic powders or the content thereof.

In the case of the toner of the present invention, the absolute specific gravity of a non-magnetic toner is preferably 0.9 to 1.2 g/cm³. The absolute specific gravity of a magnetic toner is preferably 0.9 to 4.0 g/cm³, though it depends on a kind of magnetic powders or the content thereof. The absolute specific gravity of the toner is calculated as follows. 1.000 g of the toner is precisely weighed, poured in a 10 mm Φ tableting machine and compressed at a pressure of 200 kgf/cm² under vacuum to make tablets. The height of this columnar tablet is measured with a micrometer, and the absolute specific gravity is calculated therefrom.

The flowability of a toner is defined, for example, by a flowing repose angle and a still repose angle measured by a device for measuring the angle of repose (for example, by Tsutsui Scientific Instruments Co., Ltd.). In the case of the toner for static electric charge development wherein the charge control agent of the present invention is used, a flowing repose angle is preferably 5 to 45° and a still repose angle is preferably 10 to 50°.

As for the toner of the present invention, the average value of shape factor (SF-1) of the crushed toner is preferably 100 to 400; and the average value of shape factor 2 (SF-2) thereof is preferably 100 to 350.

In the present invention, SF-1 and SF-2 each of which indicates shape factor of the toner were calculated as follows, for example. Toner particles magnified 1000 diameters were taken as a sample so that around 30 particles appear in one visual field by using a light microscope with a CCD camera (such as BH-2 by Olympus Corporation). The obtained image was transferred to an image analyzer (such as LUZEX FS by Nireco Corporation). The same procedure was repeated until the number of toner particles reaches about 1000 and the shape factor was calculated. Shape factor (SF-1) and shape factor 2 (SF-2) are calculated by the following formulae.

SF-1=((ML²×π)/4A)×100

wherein, ML is the maximum length of particles; A is a projected area of one particle,

SF-2=(PM²/4Aπ)×100

wherein, PM is the peripheral length of particles; A is a projected area of one particle.

SF-1 indicates deformation of a particle. SF-1 becomes closer to 100 when a particle becomes closer to a sphere, and the slenderer a particle is, the larger SF-1 is. SF-2 indicates concavity and convexity of a particle. SF-2 becomes closer to 100 when a particle becomes closer to a sphere, and the more complicated the shape of a particle is, the larger SF-2 is.

The volume resistivity of the toner of the present invention is preferably 1×10¹² to 1×10¹⁶Ω· cm in the case of a non-magnetic toner. The volume resistivity of a magnetic toner is preferably 1×10⁸ to 1×10¹⁶Ω· cm, though it depends on a kind of magnetic powders or the content thereof. Here, the volume resistivity of the toner is defined as follows. Toner particles are compressed to prepare a disk-shaped test piece of 50 mm in diameter and 2 mm thick. This piece is set to electrodes for solid materials (such as SE-70 by Ando Electric Co., Ltd.), and direct voltage 100V is continuously applied to the piece. Then, the value thereof one hour later is measured with a high insulation resistance meter (for example, 4339A by Hewlett-Packard Company) and defined as the volume resistivity.

The dielectric tangent of the toner of the present invention is preferably 1.0×10⁻³ to 15.0×10⁻³ in the case of a non-magnetic toner. The dielectric tangent of a magnetic toner is preferably 2×10⁻³ to 30×10⁻³, though it depends on a kind of magnetic powders or the content thereof. Here, the dielectric tangent of the toner is defined as follows. Toner particles are compressed to prepare a disk-shaped test piece of 50 mm in diameter and 2 mm thick. This piece is set to electrodes for solid materials and measured in measurement frequency of 1 KHz and peak-to-peak voltage 0.1 KV with a LCR meter (for example, 4284A by Hewlett-Packard Company). Thus obtained value is defined as the dielectric tangent value (Tan δ).

The Izod impact level of the toner of the present invention is preferably 0.1 to 30 kg·cm/cm. Here, the Izod impact level of the toner is measured by the method comprising the steps of fusing toner particles by heat to prepare a plate-like test piece; and measuring the pieces in accordance with JIS K-7110 (Izod impact test of rigid plastic).

The melt index (MI) of the toner of the present invention is preferably 10 to 150 g/10 min. Here, MI of the toner is measured in accordance with JIS K-7210 (A method), and at that time, the measurement temperature is 125° C. and weight is 10 kg.

The melting start temperature of the toner of the present invention is preferably 80 to 180° C., and 4 mm descent temperature is preferably 90 to 220° C. Here, the melting start temperature of the toner is measured by the following method. Toner particles are compressed to prepare a column-shaped test piece of 10 mm in diameter and 20 mm thick. This piece is set to a thermofusion property measurement device such as a flowtester (for example, CFT-500 C by Shimadzu Corporation) and measured in load of 20 kgf/cm2. Under such condition, the temperature at which the fusion starts and a piston starts to descend is defined as the melting start temperature. Further, in the same measurement, the temperature at which the piston descends 4 mm is defined as 4 mm descent temperature.

The glass transition temperature (Tg) of the toner of the present invention is preferably 35 to 80° C., and more preferably 40 to 75° C. Here, the glass transition temperature of the toner is measured with a differential scanning calorimetry (hereinafter referred to as DSC) by the method comprising the steps of heating the toner at a constant temperature, rapidly cooling it down, and heating it again. Tg is defined as the value determined from the peak of phase-change which occurs at that time. When Tg of the toner is within the above range, it is preferable in that anti-offset property and preservative quality thereof are high, and the fixity level of images becomes also high.

In the endothermic peak observed in the DSC measurement of the toner of the present invention, it is preferable that the peak-top temperature of the maximum peak is within 70 to 120° C.

The melt viscosity of the toner of the present invention is preferably 1000 to 50000 poise and more preferably 1500 to 38000 poise. Here, the melt viscosity of the toner is measured as follows. Toner particles are compressed to prepare a column-shaped test piece of 10 mm in diameter and 20 mm thick. These pieces are set to a thermofusion property measurement device such as a flowtester (for example, CFT-500 C by Shimadzu Corporation) and measured in load of 20 kgf/cm². Thus measured value is defined as the melt viscosity.

The dissolving residue of a solvent of the toner of the present invention is preferably 0 to 30 weight % as THF insoluble matter, 0 to 40 weight % as ethyl acetate insoluble matter, and 0 to 30 weight % as chloroform insoluble matter. The dissolving residue of a solvent defined herein is calculated as follows. 1 g of toner is uniformly dissolved or dispersed in of each 100 mL solvent of THF, ethyl acetate and chloroform. The solution or dispersion solution is press filtered and a filtrate is dried and quantitated. The ratio of an insoluble substance to an organic solvent in the toner is calculated from the quantitated value and defined as the dissolving residue of a solvent.

The toner of the present invention can be used in the one-component development process, which is one of the image forming processes. The one-component development process is the process comprising the steps of providing a latent image support member with the thinned toner, and developing the latent images. The toner is usually thinned with a device wherein a toner carrying material, a toner layer thickness controlling material and a toner supply auxiliary material are equipped; and the toner supply auxiliary material and the toner carrying material, and the toner layer thickness controlling material and the toner carrying material abut each other.

The case in which the toner of the present invention is used in the two-component development process is further illustrated as follows. The two-component development process is the process wherein a toner and a carrier (those having roles as a charge provider and a toner carrying material) are used. The above magnetic materials or glass beads are used as a carrier. Developers (toner and a carrier) generate a specific charge amount by being stirred by a stirring material, and they are carried to a developing part by a magnet roller or the like. On the magnet roller, the developers are kept on the surface of the roller by magnetic force, and they form a magnetic brush whose layer is controlled to a suitable height by a developer control plate or the like. The developers move on the development roller as the roller rotates, and contact with an electrostatic latent image support member or face against it in a specific distance and in the noncontact condition to develop and visualize latent images. When developing images in the noncontact condition, a toner can usually obtain the driving force of flying the space of a specific distance by generating a direct electric field between developers and a latent image support member. However, in order to develop clearer images, it is possible to apply the method of superimposing alternating current.

Further, the charge control agent of the present invention is suitable for a charge control agent (a charge enhancer) in coating compounds for coating electrostatic powders. Namely, coating compounds for coating electrostatic powders using said charge enhancer are excellent in environment resistance and preservation stability, and particularly thermal stability and durability. Besides, the coating efficiency thereof reaches 100% and, therefore, it is possible to form thick film without coating defect.

### Example 1

Next, Examples will further illustrate the present invention. They only explain the present invention and do not particularly limit the invention.

120.2 g (0.8 mol) of 4-tert-butylphenol, 51.3 g (1.6 mol) of sulfur and 16.0 g (0.4 mol) of sodium hydroxide were poured in a 1 L four-neck flask with a mixer, a cooling tube, a thermometer and a gas-introducing tube. 360.5 g of diphenyl ether was added thereto and stirred in the current of nitrogen gas while keeping it at 130° C. The reaction was conducted for 1 hour with removing water and hydrogen sulfide each of which was generated in the reaction. The reaction was further conducted for 1 hour after heating it up to 170° C., and then for 18 hours after heating it up to 230° C., with removing water and hydrogen sulfide each of which was generated in the reaction. The reaction mixture was cooled down to room temperature, and 80 mL of an aqueous solution of 3 mol/L of a sulfuric acid was added thereto and hydrolyzed. Then, 200 mL of a mixed solvent of isopropyl alcohol/water (88/12, v/v) was added thereto, and crude crystals precipitated. The crude crystals were taken out by filtration and washed once with 200 mL of a mixed solvent of isopropyl alcohol/water (88/12, v/v) and twice with 240 mL of water, and further washed once with 200 mL of a mixed solvent of isopropyl alcohol/water (88/12, v/v). The crystals were dried overnight under reduced pressure at 120° C. to obtain 113.2 g of a crude substance.

The relative proportions of the obtained crude substance and the like were analyzed by a high performance liquid chromatography (hereinafter referred to as HPLC). The HPLC measurement condition is as follows: device: LC-6A by Shimadzu Corporation; column: Develosil ODS-HG-5 (inside diameter 4.6, column length 250 mm) by Nomura Chemical Co., Ltd.; column temperature: 40° C.; mobile phase: THF/acetonitrile/water/trifluoroacetic acid=450/400/150/2 (v/v/v/v); current speed: 1.0 mL/min.; filling amount: 1 μL; and concentration of a sample: 1000 ppm.

The results of the HPLC analysis clarified that the crude substance was a mixture which comprises a cyclic quatromer wherein, in the formula (1), R is tert-butyl, m=4, n=0 and all of Y are hydrogen atoms, indicating the peak area ratio of 96.1%; and a cyclic octamer wherein, in the formula (1), R is tert-butyl, m=8, n=0 and all of Y are hydrogen atoms, indicating the peak area ratio of 3.6%.

100 g of the crude substance was dispersed in 200 mL of THF and stirred overnight at room temperature. The precipitated crystals were taken out by filtration and washed with 90 mL of THF. The crystals were dried overnight under reduced pressure at 120° C. to obtain 83.6 g of a crude product. The crude product was analyzed under the above HPLC measurement condition, and it was clarified that the crude product comprises a cyclic quatromer wherein, in the formula (1), R is tert-butyl, m=4, n=0 and all of Y are hydrogen atoms, indicating the peak area ratio of 99.1%.

8.65 g (0.012 mol) of the crude product was poured in a 500 mL four-neck flask. 300 mL of a boric-acid buffer solution (pH 8.5 to 8.6) which was prepared by dissolving 6.18 g (0.1 mol) of a boric acid and 2.81 g (0.05 mol) of potassium hydroxide in 1 L of water was added thereto, and heated up to 50° C. 1.64 g (0.012 mol) of zinc chloride suspended in 100 mL of the boric-acid buffer solution (pH 8.5 to 8.6) was added dropwise for 1 hour. pH was 6 after the completion of the dropwise addition. Then, the mixture was stirred for 5 hours with heating up to 50° C., and then cooled down to room temperature. The reaction product was taken out by filtration under reduced pressure, washed three times with 50 mL of water and dried under reduced pressure at 120° C. to obtain 9.17 g of a compound of the present invention as white powder, wherein, in the formula (1), R is tert-butyl, m=4, n=0 and Y is zinc.

### Example 2

8.65 g (0.012 mol) of the above purified product obtained in Example 1 was poured in a 500 mL four-neck flask. 300 mL of the boric-acid buffer solution (pH 8.5 to 8.6) was added thereto, and heated up to 50° C. 2.99 g (0.012 mol) of cobalt acetate tetrahydrate suspended in 100 mL of the boric-acid buffer solution (pH 8.5 to 8.6) was added dropwise for 10 minutes. The color of the reaction solution was changed into blue when adding dropwise dark pink cobalt acetate. pH was 7.5 after the completion of the dropwise addition. Then, the mixture was stirred for 4 hours with heating up to 50° C., and then cooled down to room temperature. The reaction product was taken out by filtration under reduced pressure, washed three times with 50 mL of water and dried under reduced pressure at 120° C. to obtain 9.29 g of a compound of the present invention as brownish yellow powder, wherein, in the formula (1), R is tert-butyl, m=4, n=0 and Y is cobalt.

### Example 3

56.2 g (0.078 mol) of a cyclic phenol sulfide wherein, in the formula (1), R is tert-butyl, m=4, n=0 and all of Y are hydrogen atoms, 224.8 g (4-fold wt/wt) of an acetic acid, 5.15 g (0.0156 mol) of sodium tungstate dihydrate and 5.31 g (0.039 mol) of sodium acetate trihydrate were poured in a 500 mL four-neck flask with a mixer, a cooling tube and a thermometer, and heated up to 60° C. with stirring. 121.2 g (1.248 mol) of 35% hydrogen peroxide water was added dropwise thereto for about 1.5 hour with stirring. After the completion of the dropwise addition, the mixture was further stirred for 15 hours at 60° C., and then for 15 hour at 70° C. 15.8 g (0.156 mol) of 36% hydrochloric acid was added dropwise thereto at 80° C. with stirring, and further stirred for 1 hour at 80° C. The mixture was cooled down to room temperature, and a white solid substance precipitated. The white solid substance was taken out by filtration under reduced pressure, washed three times with 80 mL of water and vacuum dried at 80° C. for 24 hours to obtain 58.3 g (yield 88%) of an oxidized cyclic quatromer wherein, in the formula (1), R is tert-butyl, m=4, n=2 and all of Y are hydrogen atoms.

The obtained oxidized cyclic quatromer was analyzed by HPLC. The measurement condition of HPLC is as follows: device: LC-6A by Shimadzu Corporation; column: Develosil ODS-HG-5 (inside diameter 4.6, column length 250 mm) by Nomura Chemical Co., Ltd.; column temperature: 40° C.; mobile phase: THF/acetonitrile/water/trifluoroacetic acid=350/350/300/2 (v/v/v/v); current speed: 1.0 mL/min.; filling amount: 1 μL; and concentration of a sample: 1000 ppm. The result of the analysis by HPLC clarified that the oxidized cyclic quatromer wherein, in the formula (1), R is tert-butyl, m=4, n=2 and all of Y are hydrogen atoms indicates the peak area ratio of 99.3%.

8.49 g (0.01 mol) of the oxidized cyclic quatromer and 370 g of water were poured in a 500 mL four-neck flask, and heated up to 50° C. 7.98 g (0.02 mol) of 10% (w/v) NaOH aqueous solution was added dropwise thereto. 4.28 g (0.01 mol) of 38% (w/v) ferric chloride aqueous solution was added dropwise to the obtained cream-colored suspension for 2.5 hours. The reaction solution became a purple suspension (pH=3). The reaction solution was stirred for 3 hours with heating up to 50° C., and then cooled down to room temperature. The reaction product was taken out by filtration under reduced pressure, washed three times with 50 mL of water and dried under reduced pressure at 120° C. to obtain 8.97 g of a compound of the present invention as brownish-red powder, wherein, in the formula (1), R is tert-butyl, m=4, n=2 and Y is iron.

### Example 4

8.49 g (0.01 mol) of the oxidized cyclic quatromer obtained in Example 3 was poured in a 500 mL four-neck flask. 300 mL of the boric-acid buffer solution (pH 8.5 to 8.6) was added thereto, and heated up to 50° C. 1.47 g (0.01 mol) of calcium chloride dihydrate dissolved in 100 mL of the boric-acid buffer solution (pH 8.5 to 8.6) was added dropwise for 2 hours. pH was 7.5 to 8 after the completion of the dropwise addition. Then, the mixture was stirred for 1.5 hours with heating up to 50° C., and then cooled down to room temperature. The reaction product was taken out by filtration under reduced pressure, washed three times with 50 mL of water and dried under reduced pressure at 120° C. to obtain 9.12 g of a compound of the present invention as white powder, wherein, in the formula (1), R is tert-butyl, m=4, n=2 and Y is calcium.

### Example 5

94 parts by weight of a styrene-acrylate copolymer resin (CPR-100 by Mitsui Chemicals, Inc.), 1 part by weight of the zinc compound of the cyclic phenol sulfide synthesized in Example 1, and 5 parts by weight of carbon black (MA-100 by Mitsubishi Chemical Corporation) were mixed by melting at 110° C. with a heat mixing machine. Then, the cooled down mixture was roughly crushed with a hammer mill. Then, the mixture was finely crushed with a jet mill and classified to obtain a black toner having the average particle diameter on the volumetric basis of 10±0.5 μm. 4 parts by weight of the toner and 100 parts by weight of a non-coat ferrite carrier (F-150 by Powdertech Co., Ltd.) were mixed and shaken to charge the toner negatively. Then, each of time constant which shows charging risetime and a saturated charge amount was measured with a blow-off powder charge amount measurement device at 25° C. and at 50% humidity. The results are shown in Table 1.

### Comparative Example A

For comparison, a toner was prepared by the same method as that of Example 5 except that the zinc compound of the cyclic phenol sulfide synthesized in Example 1 was changed to the cyclic quatromer obtained in Example 1 wherein, in the formula (1), R is tert-butyl, m=4, n=0 and all of Y are hydrogen atoms. Then, the time constant and the saturated charge amount thereof were measured. The results are shown in Table 1.

### Comparative Example B

For comparison, a toner was prepared by the same method as that of Example 5 except that the zinc compound of the cyclic phenol sulfide synthesized in Example 1 was changed to the oxidized cyclic quatromer obtained in Example 3 wherein, in the formula (1), R is tert-butyl, m=4, n=2 and all of Y are hydrogen atoms. Then, the time constant and the saturated charge amount thereof were measured. The results are shown in Table 1.

### Example 6

A toner was prepared by the same method as that of Example 5 except that the zinc compound of the cyclic phenol sulfide synthesized in Example 1 was changed to the cobalt compound of the cyclic phenol sulfide synthesized in Example 2. Then, the time constant and the saturated charge amount thereof were measured. The results are shown in Table 1.

### Example 7

A toner was prepared by the same method as that of Example 5 except that the zinc compound of the cyclic phenol sulfide synthesized in Example 1 was changed to the iron compound of the oxidized cyclic phenol sulfide synthesized in Example 3. Then, the time constant and the saturated charge amount thereof were measured. The results are shown in Table 1.

### Example 8

A toner was prepared by the same method as that of Example 5 except that the zinc compound of the cyclic phenol sulfide synthesized in Example 1 was changed to the calcium compound of the oxidized cyclic phenol sulfide synthesized in Example 4. Then, the time constant and the saturated charge amount thereof were measured. The results are shown in Table 1.

### Comparative Example 1

For comparison, a toner was prepared by the same method as that of Example 5 except that the zinc compound of the cyclic phenol sulfide synthesized in Example 1 was changed to a zinc complex of a salicylic acid. Then, the time constant and the saturated charge amount thereof were measured. The results are shown in Table 1.

### Comparative Example 2

For comparison, a toner was prepared by the same method as that of Example 5 except that the zinc compound of the cyclic phenol sulfide synthesized in Example 1 was changed to an aluminum complex of a salicylic acid. Then, the time constant and the saturated charge amount thereof were measured. The results are shown in Table 1.

### Comparative Example 3

For comparison, a toner was prepared by the same method as that of Example 5 except that the zinc compound of the cyclic phenol sulfide synthesized in Example 1 was changed to calixarene. Then, the time constant and the saturated charge amount thereof were measured. The results are shown in Table 1.

### Example 9

94 parts by weight of a styrene-acrylate copolymer resin (CPR-100 by Mitsui Chemicals, Inc.), 1 part by weight of the zinc compound of the cyclic phenol sulfide synthesized in Example 1, and 5 parts by weight of carbon black (MA-100 by Mitsubishi Chemical Corporation) were mixed by melting at 110° C. with a heat mixing machine. Then, the cooled down mixture was roughly crushed with a hammer mill. Then, the mixture was finely crushed with a jet mill and classified to obtain a black toner having the average particle diameter on the volumetric basis of 10±0.5 μm. 4 parts by weight of the toner and 100 parts by weight of a silicone coated ferrite carrier (F96-150 by Powdertech Co., Ltd.) were mixed and shaken to charge the toner negatively. Then, each of time constant which shows charging risetime and a saturated charge amount was measured with a blow-off powder charge amount measurement device at 25° C. and at 50% humidity. The results are shown in Table 1.

### Comparative Example C

For comparison, a toner was prepared by the same method as that of Example 9 except that the zinc compound of the cyclic phenol sulfide synthesized in Example 1 was changed to the cyclic quatromer obtained in Example 1 wherein, in the formula (1), R is tert-butyl, m=4, n=0 and all of Y are hydrogen atoms. Then, the time constant and the saturated charge amount thereof were measured. The results are shown in Table 1.

### Comparative Example D

For comparison, a toner was prepared by the same method as that of Example 9 except that the zinc compound of the cyclic phenol sulfide synthesized in Example 1 was changed to the oxidized cyclic quatromer obtained in Example 3 wherein, in the formula (1), R is tert-butyl, m=4, n=2 and all of Y are hydrogen atoms. Then, the time constant and the saturated charge amount thereof were measured. The results are shown in Table 1.

### Example 10

A toner was prepared by the same method as that of Example 9 except that the zinc compound of the cyclic phenol sulfide synthesized in Example 1 was changed to the cobalt compound of the cyclic phenol sulfide synthesized in Example 2. Then, the time constant and the saturated charge amount thereof were measured. The results are shown in Table 1.

### Example 11

A toner was prepared by the same method as that of Example 9 except that the zinc compound of the cyclic phenol sulfide synthesized in Example 1 was changed to the iron compound of the oxidized cyclic phenol sulfide synthesized in Example 3. Then, the time constant and the saturated charge amount thereof were measured. The results are shown in Table 1.

### Example 12

A toner was prepared by the same method as that of Example 9 except that the zinc compound of the cyclic phenol sulfide synthesized in Example 1 was changed to the calcium compound of the oxidized cyclic phenol sulfide synthesized in Example 4. Then, the time constant and the saturated charge amount thereof were measured. The results are shown in Table 1.

### Comparative Example 4

For comparison, a toner was prepared by the same method as that of Example 9 except that the zinc compound of the cyclic phenol sulfide synthesized in Example 1 was changed to a zinc complex of a salicylic acid. Then, the time constant and the saturated charge amount thereof were measured. The results are shown in Table 1.

### Comparative Example 5

For comparison, a toner was prepared by the same method as that of Example 9 except that the zinc compound of the cyclic phenol sulfide synthesized in Example 1 was changed to an aluminum complex of a salicylic acid. Then, the time constant and the saturated charge amount thereof were measured. The results are shown in Table 1.

### Comparative Example 6

For comparison, a toner was prepared by the same method as that of Example 9 except that the zinc compound of the cyclic phenol sulfide synthesized in Example 1 was changed to calixarene. Then, the time constant and the saturated charge amount thereof were measured. The results are shown in Table 1.

TABLE 1

| | | | Saturated | |
|---|---|---|---|---|
| | | | charge | |
| | | Ferrite | amount | Time |
| | Name of compound | carrier | (−μc/g) | constant |
| Example 5 | Compound synthesized | F-150 | 32.0 | 185 |
| | in Example 1 | | | |
| Example 6 | Compound synthesized | F-150 | 29.6 | 167 |
| | in Example 2 | | | |
| Example 7 | Compound synthesized | F-150 | 36.5 | 169 |
| | in Example 3 | | | |
| Example 8 | Compound synthesized | F-150 | 39.5 | 150 |
| | in Example 4 | | | |
| Comp. | Zn complex of a salicylic | F-150 | 23.1 | 169 |
| Example 1 | acid | | | |
| Comp. | Al complex of a salicylic | F-150 | 12.7 | 99 |
| Example 2 | acid | | | |
| Comp. | Calixarene | F-150 | 29.3 | 227 |
| Example 3 | | | | |
| Comp. | Quartromer | F-150 | 19.7 | 345 |
| Example A | | | | |
| Comp | Oxidized quatromer | F-150 | 26.4 | 323 |
| Example B | | | | |
| Example 9 | Compound synthesized | F96-150 | 17.7 | 107 |
| | in Example 1 | | | |
| Example 10 | Compound synthesized | F96-150 | 17.4 | 88 |
| | in Example 2 | | | |
| Example 11 | Compound synthesized | F96-150 | 22.6 | 102 |
| | in Example 3 | | | |
| Example 12 | Compound synthesized | F96-150 | 27.6 | 85 |
| | in Example 4 | | | |
| Comp. | Zn complex of a salicylic | F96-150 | 15.1 | 112 |
| Example 4 | acid | | | |
| Comp. | Al complex of a salicylic | F96-150 | 9.0 | 90 |
| Example 5 | acid | | | |
| Comp. | Calixarene | F96-150 | 6.3 | 182 |
| Example 6 | | | | |
| Comp. | Quartromer | F96-150 | 14.8 | 141 |
| Example C | | | | |
| Comp. | Oxidized quatromer | F96-150 | 13.3 | 185 |
| Example D | | | | |

As mentioned above, it was clarified that the metal compound of a cyclic phenol sulfide of the present invention has excellent charging performance; that a charge control agent containing said compound has excellent charge providing effect; and that a negative electric toner containing said charge control agent has high charging performance.

Particularly, when comparing performances between Comparative Examples A, B, C and D (each using a compound wherein all of Y in the formula (1) are hydrogen atoms) and Examples 5, 7, 9 and 11 (each using a compound wherein a part of Y in the formula (1) is a metal atom) each other, by preparing a compound wherein a part of Y is a metal atom, the saturated charge amount thereof becomes larger and the time constant thereof becomes smaller, which means that it has a quick charging risetime. Thus, the charge control agent of the present invention is further more suitable for recent high speed printers.

The metal compound of a cyclic phenol sulfide of the present invention has excellent charging performance, and a charge control agent containing said compound has higher charging performance than conventional charge control agents. Further, it becomes possible to provide a novel toner applicable to recent high speed printers. Besides, since some of the metal compounds of a cyclic phenol sulfide of the present invention are colorless (white), they are also useful as color toners.

1. A charge control agent comprising a metal compound of a cyclic phenol sulfide of the following formula (1) as an active ingredient: 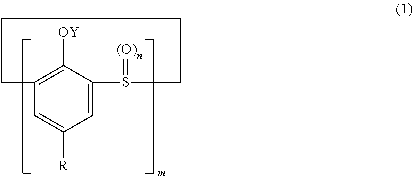
wherein R is a straight or branched alkyl group having 1 to 6 carbon atoms, a cyclic hydrocarbon group having 3 to 8 carbon atoms, a straight or branched unsaturated hydrocarbon group having 2 to 6 carbon atoms, or a substituted or unsubstituted aromatic hydrocarbon group; Y is a hydrogen atom or a metal atom; m is an integer from 4 to 9; and n is an integer of 0, 1 or 2, provided that at least one of several Y is a metal atom.

2. The charge control agent according to claim 1 comprising the metal compound of a cyclic phenol sulfide of the formula (1) wherein m=4.

3. The charge control agent according to claim 1 comprising the metal compound of a cyclic phenol sulfide of the formula (1) wherein m=6.

4. The charge control agent according to claim 1 comprising the metal compound of a cyclic phenol sulfide of the formula (1) wherein m=8.

5. The charge control agent according to claim 2 comprising the metal compound of a cyclic phenol sulfide of the formula (1) wherein n=0.

6. The charge control agent according to claim 2 comprising the metal compound of a cyclic phenol sulfide of the formula (1) wherein n=2.

7. A toner which comprises one or more kinds of the metal compound of a cyclic phenol sulfide of the formula (1) according to claim 1, a coloring agent and a binder resin.

8. A toner which comprises one or more kinds of the metal compound of a cyclic phenol sulfide of the formula (1) according to claim 1 wherein m=4, a coloring agent and a binder resin.

9. A toner which comprises one or more kinds of the metal compound of a cyclic phenol sulfide of the formula (1) according to claim 1 wherein m=6, a coloring agent and a binder resin.

10. A toner which comprises one or more kinds of the metal compound of a cyclic phenol sulfide of the formula (1) according to claim 1 wherein m=8, a coloring agent and a binder resin.

11. A toner which comprises one or more kinds of the metal compound of a cyclic phenol sulfide of the formula (1) according to claim 1 wherein n=0, a coloring agent and a binder resin.

12. A toner which comprises one or more kinds of the metal compound of a cyclic phenol sulfide of the formula (1) according to claim 1 wherein n=2, a coloring agent and a binder resin.
